(19) United States
(12) Patent Application Publication
(10) Pub. No.: US 2026/0219627 A1
(43) Pub. Date: Jul. 30, 2026

(54) MODULE AND IMAGE FORMING APPARATUS

(71) Applicant: Naoki KIKUCHI, Kanagawa (JP)

(72) Inventor: Naoki KIKUCHI, Kanagawa (JP)

(73) Assignee: ETRIA CO., LTD., Yokohama, Kanagawa (JP)

(21) Appl. No.: 19/335,748

(22) Filed: Sep. 22, 2025

(30) Foreign Application Priority Data
Jan. 29, 2025 (JP) 2025-012840

(51) Int. Cl. G03G 15/00; G03G 15/04

(52) U.S. Cl. CPC G03G 15/80; G03G 15/04072

(57) ABSTRACT

A module includes a unit including a connector including multiple terminals connectable to multiple signal wires. The multiple terminals include open terminals. The multiple signal wires are connectable to the open terminals. The multiple signal wires include a looped signal wire having a looped end. The looped signal wire includes a twisted portion between the looped end and the open terminals.

### CROSS-REFERENCE TO RELATED APPLICATIONS

This patent application is based on and claims priority pursuant to 35 U.S.C. § 119(a) to Japanese Patent Application No. 2025-012840, filed on Jan. 29, 2025, in the Japan Patent Office, the entire disclosure of which is hereby incorporated by reference herein.

### BACKGROUND

### Technical Field

Embodiments of the present disclosure relate to a module and an image forming apparatus.

### Related Art

A short circuit (loop circuit) is used for an electric wire and a joint connector.

### SUMMARY

In an embodiment of the present disclosure, a module includes a unit including a connector including multiple terminals connectable to multiple signal wires. The multiple terminals include open terminals. The multiple signal wires are connectable to the open terminals. The multiple signal wires include a looped signal wire having a looped end. The looped signal wire includes a twisted portion between the looped end and the open terminals.

In another embodiment of the present disclosure, a writing unit includes the module. The unit includes a laser diode (LD) unit to emit a laser beam in accordance with a laser drive signal input via the multiple signal wires.

In still another embodiment of the present disclosure, an image forming apparatus includes the writing unit.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic cross-sectional view of a writing unit provided for a color image forming apparatus;

FIG. 2 is a schematic diagram illustrating a writing unit provided for the image forming apparatus of FIG. 1, viewed from above;

FIG. 3 is another schematic diagram illustrating the writing unit of FIG. 2;

FIG. 4A is a block diagram illustrating a functional configuration of a writing unit provided for a color image forming apparatus;

FIG. 4B is a block diagram illustrating a functional configuration of a writing unit provided for a monochrome image forming apparatus;

FIG. 4C is a block diagram illustrating a functional configuration of a writing unit provided for a monochrome image forming apparatus when the writing unit of FIG. 4A and the writing unit of FIG. 4B are combined to be employed as the writing unit for the monochrome image forming apparatus;

FIG. 5 is a diagram illustrating a case in which a looped signal wire is twisted in a writing unit;

FIG. 6 is a diagram illustrating the length of a looped signal wire in an image forming apparatus;

FIG. 7 is a diagram illustrating a case in which the length of a looped signal wire does not affect ease of assembling of a writing unit;

FIG. 8 is a diagram illustrating a case in which a looped signal wire is fixed to adjacent signal wires by binding;

FIG. 9 is a diagram illustrating a combination of looped signal wires connected to a connector; and

FIG. 10 is a diagram illustrating an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below in detail of a module, i.e., a writing unit, and an image forming apparatus with reference to the accompanying drawings.

The module and the image forming apparatus perform as follows with respect to deterioration of electromagnetic interference (EMI) characteristics when a terminal is open terminal due to deletion of a signal wire. For example, there is a need to employ a single apparatus body for both a color printing apparatus and a monochrome printing apparatus. To meet such a need, there is a demand for a configuration in which both a color printing unit and a monochrome printing unit are installed and connected to such a single apparatus body of an image forming apparatus. When a writing unit that is shared by the color printing unit and the monochrome printing unit is employed as the writing unit for monochrome printing, signal wires for the color printing unit are not used. Accordingly, terminals of the color printing unit to which the signal wires are connected become vacant and open terminals.

When another signal wire operates on a same circuit board including the open terminal, the open terminal is floating. For this reason, it is necessary to terminate the open terminal with a looped signal wire. However, when the looped signal wire alone is connected to the ground (GND) indirectly via another component on the circuit board, the signal wire that is operating affects a signal wire that is not operating. As a result, the looped signal wire leaks noise to the outside.

In the module, the looped signal wire is twisted and the twisted looped signal wire is attached to the open terminal. The EMI characteristics of the module can be prevented from being reduced. In the following description, a signal wire that has ends connected to terminals is defined as the looped signal wire. In other words, in the module, the ends of the twisted looped signal wire are attached to the open terminals. The noise that is emitted from the looped signal wire to the outside is reduced and the EMI characteristics can be prevented from deteriorating. A writing unit as the module according to embodiments of the present disclosure is described below in detail with reference to the drawings.

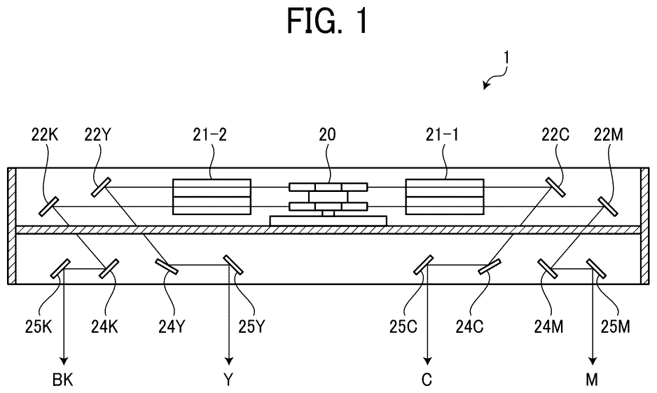

FIG. 1 is a schematic cross-sectional view of a writing unit 1 as a module provided for a color image forming apparatus. The writing unit 1 of the color image forming apparatus includes, for example, a polygon mirror 20 which is a rotating polygon mirror, fθ lenses 21-1 and 21-2, first mirrors 22K, 22Y, 22C, and 22M, second mirrors 24K, 24Y, 24C, and 24M, and third mirrors 25K, 25Y. 25C, and 25M. The writing unit 1 of the color image forming apparatus forms images of four colors of black (K), yellow (Y), cyan (C), and magenta (M).

In an image forming apparatus, typically, four independent writing units form images of four colors. However, the single writing unit 1 forms images of four colors as described below. In the writing unit 1, the signal wires of yellow (Y), cyan (C), and magenta (M) colors are deleted for the monochrome printing unit, and the writing unit 1 of the color printing unit is employed for the monochrome printing unit. In the writing unit 1, laser beams that are emitted from laser diodes mounted on laser units of respective colors are incident on the cylindrical fθ lenses 21-1 and 21-2. Each of the cylindrical fθ lenses 21-1 and 21-2 has a fixed refractive index in the sub-scanning direction, and condenses the laser beams emitted from the laser units in the sub-scanning direction and causes the laser beams to be incident on mirror surfaces of the polygon mirror 20, which is a rotating polygon mirror. The polygon mirror 20 is driven to rotate at a high speed by a motor and deflects the incident laser beams in the main-scanning direction.

In the writing unit 1, the polygon mirror 20 is disposed at the center of the writing unit 1, and the single polygon mirror 20 deflects the laser beams of the four colors in the main-scanning direction. In the writing unit 1, components such as the first mirrors 22K, 22Y, 22C, and 22M, the second mirrors 24K, 24Y, 24C, and 24M, and the third mirrors 25K, 25Y, 25C, and 25M, and the fθ lenses 21-1 and 21-2 are symmetrically around the polygon mirror 20, to lay out optical paths of laser beams of two colors on the left and right sides of the writing unit 1. The writing unit 1 deflects laser beams of the four colors by the single polygon mirror 20. In FIG. 1, the optical paths of laser beams of black (K) and yellow (Y) colors are laid out on the left side of the polygon mirror 20, and the optical paths of laser beams of cyan (C) and magenta (M) colors are laid out on the right side of the polygon mirror 20. The laser beams that are deflected by the polygon mirror 20 are reflected by the first mirrors 22K, 22Y, 22C, and 22M.

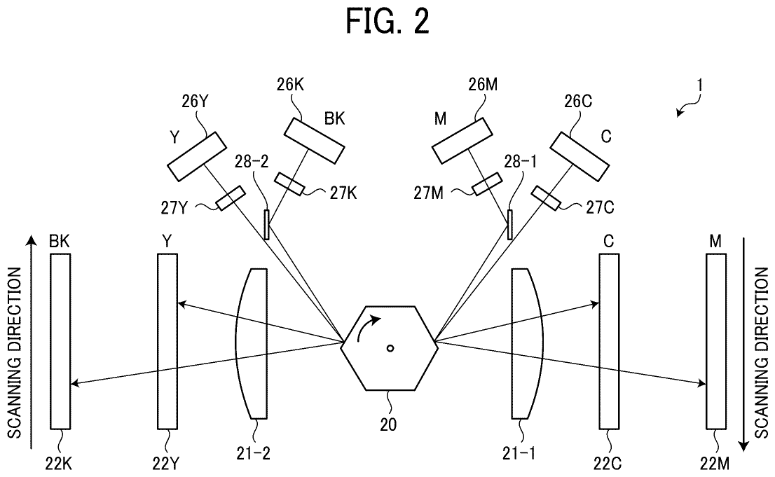

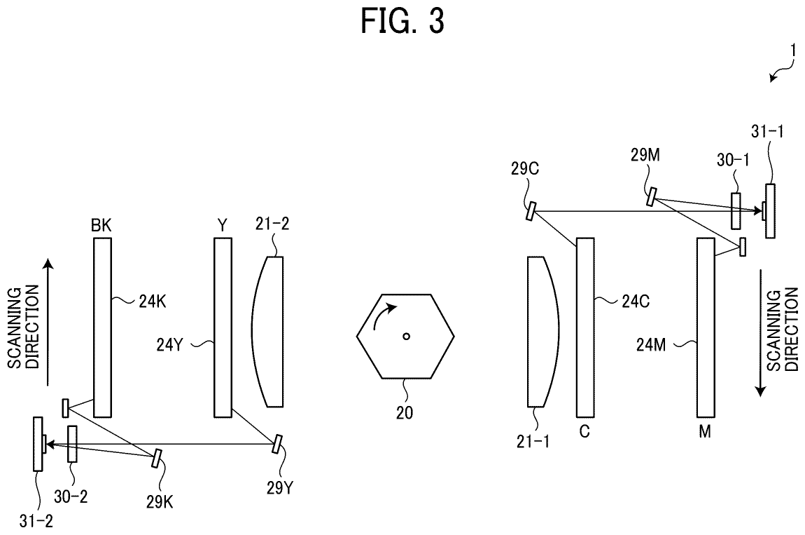

FIGS. 2 and 3 are diagrams each illustrating the writing unit 1 provided for the color image forming apparatus. In the present embodiment, the writing unit 1 includes the polygon mirror 20, the fθ lenses 21-1 and 21-2, the first mirrors 22K, 22Y, 22C, and 22M, the second mirrors 24K, 24Y, 24C, and 24M, the third mirrors 25K, 25Y. 25C, and 25M, laser units 26K, 26Y, 26C, and 26M each having a laser diode mounted thereon, cylindrical lenses 27K, 27Y, 27C, and 27M, reflection mirrors 28-1 and 28-2, synchronization-detection reflection mirrors 29K, 29Y, 29C, and 29M, synchronization detection lenses 30-1 and 30-2, and synchronization detection sensors 31-1 and 31-2.

The laser beams that are reflected by the first mirrors 22K, 22Y, 22C, and 22M are incident on the second mirrors 24K, 24Y, 24C, and 24M, respectively. The laser beams that are reflected by the second mirrors 24K, 24Y, 24C, and 24M are reflected by the third mirrors 25K, 25Y, 25C, and 25M, respectively. The reflected laser beams are emitted from the writing unit 1 and imaged on the photoconductor drums 32. As described above, in the writing unit 1, the optical components are arranged symmetrically around the polygon mirror 20, and the optical paths of laser beams of black (K) and yellow (Y) colors are laid out on the left side of the polygon mirror 20, and the optical paths of laser beams of cyan (C) and magenta (M) colors are laid out on the right side of the polygon mirror 20. The synchronization detection sensors 31-1 and 31-2 are synchronization detection signal detectors that detect a writing start reference position in the main-scanning direction. As illustrated in FIG. 3, the laser beams are reflected at specific positions on the second mirrors 24K, 24Y, 24C, and 24M in the main-scanning direction. The laser beams that are reflected by the synchronization-detection reflection mirrors 29K and 29Y are reflected on the synchronization detection lens 30-1 and enter the synchronization detection sensors 31-2. The laser beams that are reflected by the synchronization-detection reflection mirrors 29C and 29M are reflected on the synchronization detection lens 30-2 and enter the synchronous detection sensor 31-1. The synchronization detection lenses 30-1 and 30-2 are arranged to cause the incident laser beams to focus onto the synchronization detection sensors 31-1 and 31-2, respectively. The synchronization detection sensors 31-1 and 31-2 are arranged one by one on the left and right sides of the writing unit 1, and each of the synchronization detection sensors 31-1 and 31-2 detects the timing of the laser beams of the respective two colors. In other words, the synchronization detection sensor 31-1 detects the main-scanning reference positions of laser beams of cyan (C) color and magenta (M) color, and the synchronization detection sensor 31-2 detects the main-scanning reference positions of laser beams of black (K) color and yellow (Y) color.

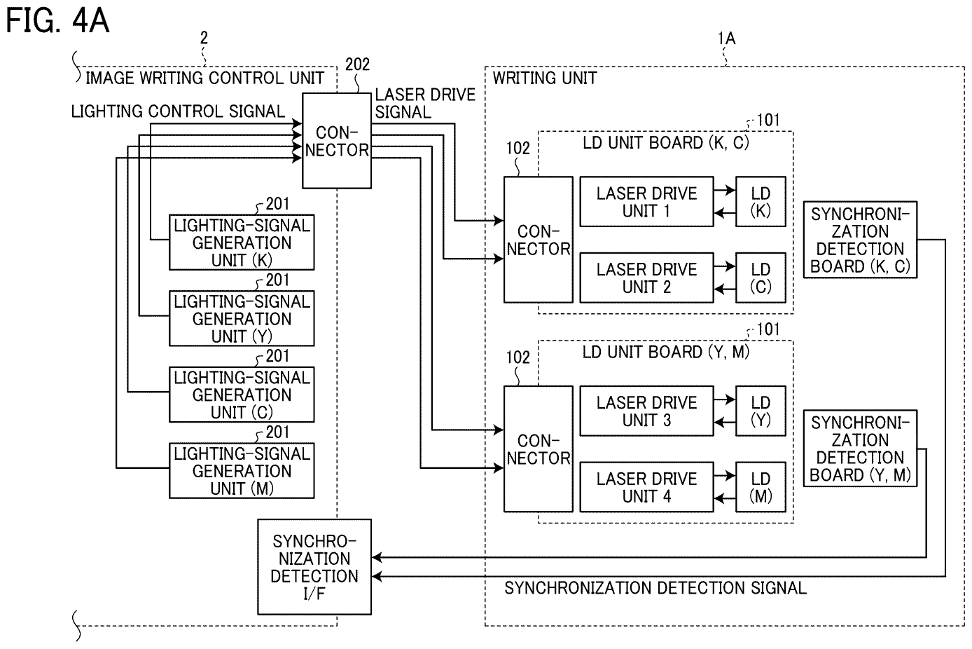

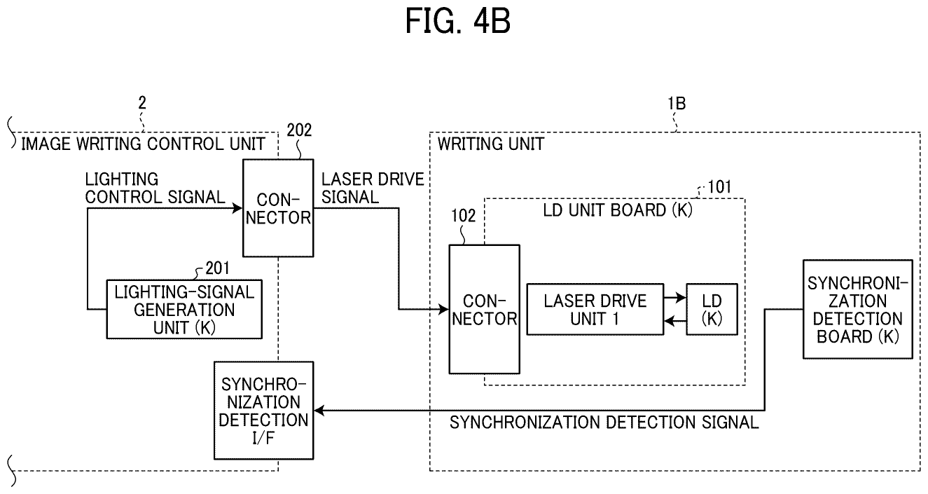

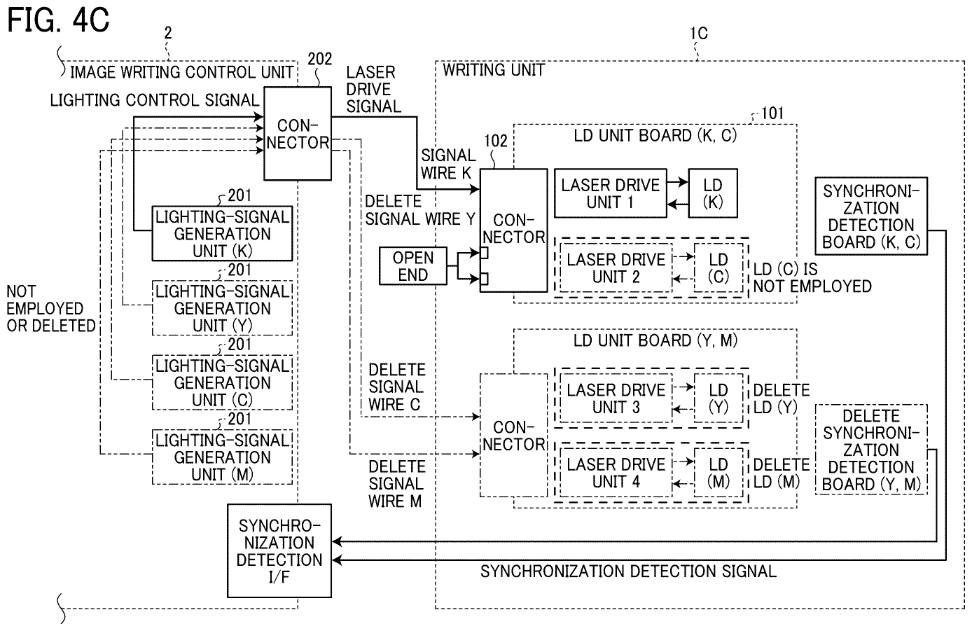

Next, a description is given of a configuration of the writing unit 1 that is shared by the color printing unit and the monochrome printing unit with reference to FIGS. 4A, 4B, and 4C. FIG. 4A is a block diagram illustrating a functional configuration of a writing unit 1A provided for a color image forming apparatus. FIG. 4B is a block diagram illustrating a functional configuration of a writing unit 1B provided for a monochrome image forming apparatus. FIG. 4C is a block diagram illustrating a functional configuration of a writing unit 1C provided for a monochrome image forming apparatus when the writing unit 1A and the writing unit 1B are integrated to be employed as the writing unit 1C.

As illustrated in FIGS. 4A, 4B, and 4C, the image forming apparatus includes an image writing control unit 2 and the writing unit 1A, 1B, or 1C. The image writing control unit 2 includes lighting-signal generation units 201. The writing units 1A, 1B, and 1C each includes laser diode (LD) unit boards 101 or a LD unit board 101. The image writing control unit 2 and the writing unit 1 are connected to each other via signal wires connected to the connector 202. The lighting-signal generation units 201 generate lighting control signals and output the lighting control signals to the LD unit boards 101 through the connector 102 as laser drive signals. Each of the LD unit board 101 includes the connector 102 having multiple terminals to which signal wires are connected. Each of the LD unit board 101 emits a laser beam in accordance with a laser drive signal input via a signal wire.

The writing unit 1A of the color printing unit illustrated in FIG. 4A includes the LD unit boards 101 of four colors of yellow (Y), magenta (M), cyan (C), and black (K). The LD unit boards 101 for black (K), cyan (C), yellow (Y), and magenta (M) colors are mounted on a same circuit board to perform color printing. The writing unit 1 of the monochrome image forming apparatus illustrated in FIG. 4B includes only the writing unit 1B for black (K) color to perform monochrome printing.

As illustrated in FIG. 4C, the writing unit 1C is a writing unit for the monochrome image forming apparatus in which the writing unit 1A and the writing unit 1B are integrated to be employed as the writing unit 1C for the monochrome image forming apparatus. In the writing unit 1C, the signal wires for yellow (Y), magenta (M), and cyan (C) colors that are not needed for monochrome printing are deleted, and only the signal wire of black (K) color is used. However, the writing unit 1C includes the LD unit board 101 for black (K) and cyan (C) colors. For this reason, the LD unit board for black (K) color and the LD unit board for cyan (C) are on a same circuit board. Thus, the terminal of the LD unit board for cyan (C) color becomes an open terminal. Noise of the signal wire of black (K) color on the same circuit board is emitted to the outside from the open terminal.

However, in the writing unit 1C for the monochrome image forming apparatus, both the writing unit 1A for the color image forming apparatus and the writing unit 1B for the monochrome image forming apparatus are connectable to the body for the monochrome image forming apparatus. For this reason, the shape of the terminals are not changeable. Accordingly, open terminals are inevitably generated and float. When a looped signal wire is simply attached to the open terminals to terminate the open terminals, the looped signal wire may generate and emit noise to the outside due to the influence of the signal wire of black (K) color operating on the same circuit board. For this reason, in the writing unit 1C as a module according to embodiments of the present disclosure, a twisted looped signal wire is attached to the open terminals to solve such a disadvantage.

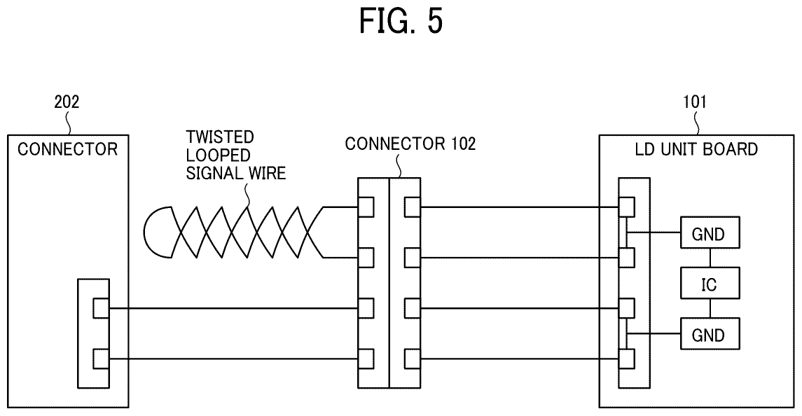

FIG. 5 is a diagram illustrating a case in which a looped signal wire is twisted in the writing unit 1C. As described above, when the looped signal wire is simply attached to the open terminals, the looped signal wire that is not operating may generate and emit noise to the outside due to the influence of an adjacent signal wire, for example, the signal wire of black (K) color. For this reason, the looped signal wire is twisted and attached to the open terminals. Twisting the looped signal wire allows the noise to be reduced, and noise inside the looped signal wire can be canceled. Accordingly, the twisted looped signal wire can reduce noise that is emitted to the outside and prevent the EMI characteristics of the image forming apparatus from deteriorating.

In other words, the signal wire that is connected to the open terminals among the terminals of the connector 102 is a looped signal wire in which the ends of the signal wire forms a loop shape and has a twisted shape. Such a configuration as described above prevents the noise due to the influence of the signal wire adjacent to the looped signal wire from being output to the outside. Thus, the EMI characteristics of the image forming apparatus can be prevented from deteriorating.

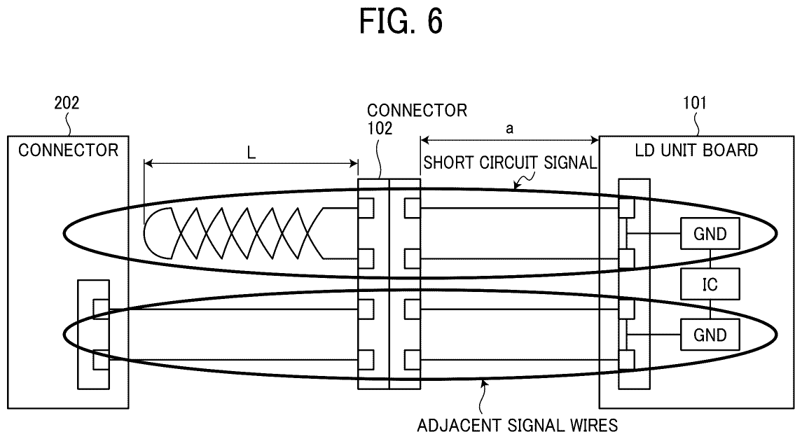

FIG. 6 is a diagram illustrating the length of the looped signal wire in the image forming apparatus. The looped signal wire through which no signal flows has a resonance frequency that matches that of the operating signal wire of black (K) color, and this causes noise to be generated. For this reason, the resonance frequency of the adjacent signal wires and the resonance frequency of the looped signal wire are changed. For example, the length of the short circuit is changed.

At this time, when the length of an entire short-circuit path is 2 (L+a), the length of a portion of the short-circuit path that can be changed is only a length L of the looped signal wire. Changing the length L of the looped signal wire can change the resonance frequency of the short circuit from the resonance frequency of the adjacent signal wire. The length L of the looped signal wire is changed from the length corresponding to the half wavelength of the resonance frequency of the looped signal wire or the integral multiple of the entire wavelength of the resonance frequency. By so doing, the resonance frequency of the looped signal wire is shifted from the frequency of the adjacent signal wire. In other words, the length L of the looped signal wire may be a length that causes the operating frequency of the adjacent signal wire and the resonance frequency of the looped signal wire not to coincide with each other.

Preferably, the length L of the looped signal wire is determined such that the operating frequency f (0) of the adjacent signal wire and the resonance frequency of the looped signal wire do not coincide with each other. The length L is calculated using a following first formula.

$$Operating Frequency of Adjacent Signal Wires \neq Resonance Frequency of Short - circuit Path \qquad First Formula$$

$$f ( 0 ) \neq \frac{v}{2 \times 2 ( L + α )}$$

In the first formula, f (0) [Hz] is the operating frequency of the adjacent signal wire, L [m] is the length of the looped signal wire when the looped signal wire is extended and is not twisted, a [m] is the length of the short-circuit path that is unchangeable, and v [m/s] is the propagation velocity of the wave.

From the first formula, the operating frequency f (n) of the integral multiple n of f (0) is expressed by a following second formula.

$$f ( n ) = n \times f ( 0 ) \qquad Second Formula$$

$$f ( n ) = \frac{nv}{4 ( L + a )}$$

In the second formula, f (n) is an integral multiple n of the operating frequency f (0), and n is a coefficient.

Accordingly, the length L is obtained from the first formula and the second formula, and the obtained length L is expressed by a following third formula.

$$L = \frac{nv}{4 f ( 0 )} - a \qquad Third Formula$$

Accordingly, in the third formula, any integral multiple n as a target of the operating frequency f (0) of the adjacent signal wire is substituted into the third formula to set a value for the length L other than the length obtained by the first and second formulas. The length L of the looped signal wire shifted from the resonance frequency can be determined.

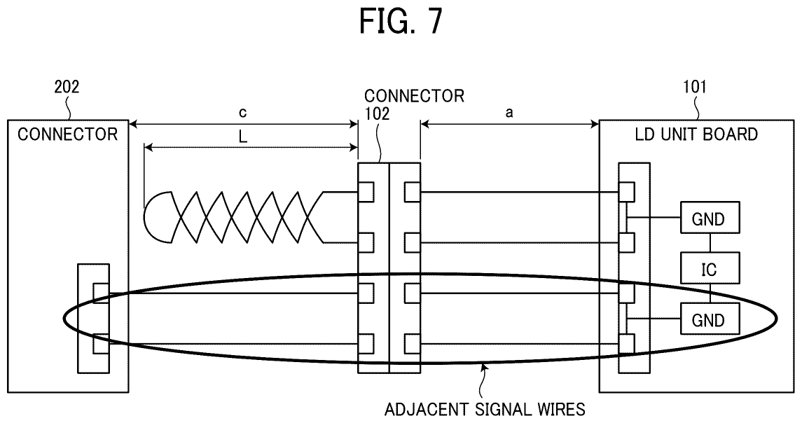

FIG. 7 is a diagram illustrating a case in which the length of the looped signal wire does not affect ease of assembling of the writing unit 1C. The length L of the looped signal wire that is calculated by the above-described third formula is set as a length other than the length matching the resonance frequency of the looped signal wire. Accordingly, there are innumerable options for the length L. However, when the looped signal wire is excessively long compared to the entire short-circuit path, the harness is sandwiched by the exterior of the writing unit 1C. Thus, the ease of assembling of the writing unit 1C is affected. When the looped signal wire is excessively short, it is difficult to attach the looped signal wire. In other words, the length L of the looped signal wire may be a length that does not affect the ease of assembling of the writing unit 1.

Accordingly, preferably, an upper limit and a lower limit of the length L of the looped signal wire are set. As an example of the upper limit and the lower limit of the length L of the looped signal wire, the lower limit of the length L is set to a length that allows the looped signal wire to be twisted one or more times, and the upper limit of the length L is set to a length within a length c of the distance from the apparatus body, i.e., the connector 202, of the image forming apparatus to the terminals of the connector 102. Accordingly, from the viewpoint of ensuring the ease of assembling of the writing unit 1C, the length L of the looped signal wire is obtained by a following fourth formula. Such a configuration can prevent the EMI characteristics of the image forming apparatus from deteriorating while maintaining the ease of assembling of the writing unit 1C.

$$Length of Looped Signal Wire that can be twisted one or more times < Length L of Looped Signal Wire < c \qquad Fourth Formula$$

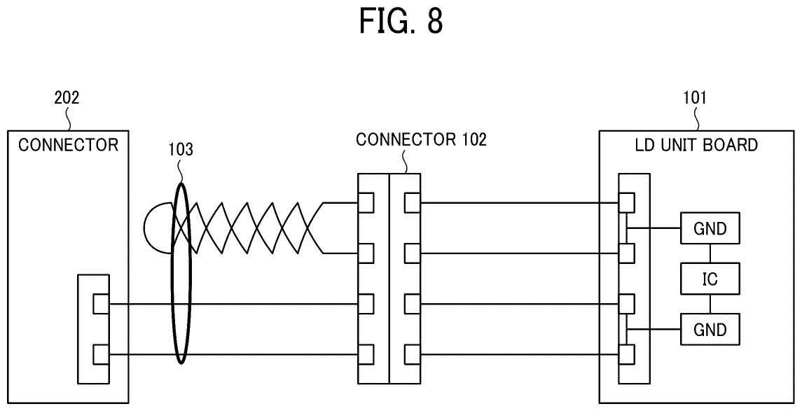

FIG. 8 is a diagram illustrating a case in which the looped signal wire is fixed to adjacent signal wires by binding. When the looped signal wire is attached to the connector 102, one or more binders 103 are used to fix a twisted portion of the first turn from a looped end of the looped signal wire to an adjacent signal wire. The twisted portion of the looped signal wire is not untied. In other words, the looped signal wire may be fixed to the adjacent signal wire by binding. At this time, the looped signal wire may be fixed by binding at the twisted portion of the first turn from the looped end of the looped signal wire.

Such a configuration as described above can maintain the effect of preventing the EMI characteristics from deteriorating due to the twisting of the looped signal wire.

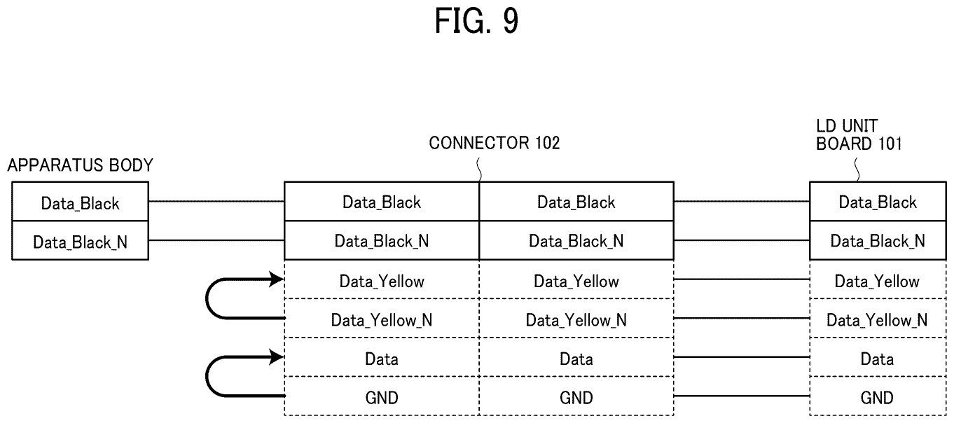

FIG. 9 is a diagram illustrating a combination of looped signal wires connected to the connector 102. When original signals of the signal wires connected to open terminals are differential signals, the differential signals may be connected to each other. When the signal wire is a single data wire, the GND may be connected to the data wire. In other words, the looped signal wire may be a looped signal wire that connects the looped signal wire and the GND or connects the differential signals to each other. Such a configuration as described above can efficiently cancel out an unnecessary signal or noise flowing into the looped signal wire or return the unnecessary signal or noise to the circuit board.

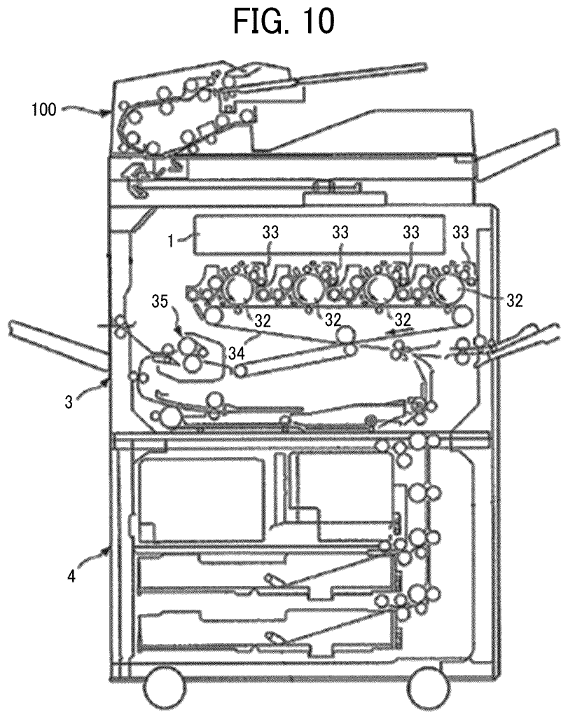

FIG. 10 is a diagram illustrating a configuration of the image forming apparatus. The image forming apparatus is a copier that includes an image forming device 3, a writing unit 1, photoconductor drums 32, developing devices 33, a transfer belt 34, and a fixing device 35. In the image forming device 3, the writing unit 1 exposes the photoconductor drums 32 to form latent images on the respective photoconductor drums 32, based on image data read by an image reading device inside the auto document feeder (ADF) 100. The developing devices 33 supplies toner of respective colors to the photoconductor drums 32 to develop latent images.

The image forming device 3 transfers toner images developed on the photoconductor drums 32 by the transfer belt 34 to a recording sheet supplied from the sheet feeder 4 and fuses toner of the toner images transferred to the recording sheet by the fixing device 35 to fix a composite color image to the recording sheet. The looped signal wires illustrated in FIGS. 6, 7, 8, and 9 are applicable to open terminals generated in the writing unit 1C. Twisting the looped signal wires can prevent noise from being emitted to the outside due to the influence of the adjacent signal wires and prevent the EMI characteristics from deteriorating.

In the above descriptions, some embodiments are described. However, for example, the configurations of the components and the content and format of signals are not limited to the above-described embodiments.

As described above, the writing unit 1C can prevent noise, which is generated due to the influence of the signal wires adjacent to the looped signal wire, from being output to the outside. Accordingly, connecting the twisted looped signal wire to the open terminals can prevent the EMI characteristics from deteriorating.

In embodiments of the present disclosure, a module includes a unit including a connector including multiple terminals connectable to multiple signal wires. The multiple terminals include open terminals. The multiple signal wires are connectable to the open terminals. The multiple signal wires include a looped signal wire having a looped end. The looped signal wire includes a twisted portion between the looped end and the open terminals.

In the module, the multiple signal wires includes the looped signal wire and an adjacent signal wire adjacent to the looped signal wire. The adjacent signal wire transmits an electrical signal at an operating frequency via the adjacent signal wire. The looped signal wire has a length, from the multiple terminals to the looped end, that causes a resonant frequency of the looped signal wire to be shifted from the operating frequency of the adjacent signal wire.

In the module, the adjacent signal wire connects the multiple terminals and an apparatus body. The looped signal wire has the length having a lower limit allowing the loop signal wire to be twisted one or more times and an upper limit of a distance from the apparatus body to the multiple terminals.

In the module, the multiple signal wires includes the looped signal wire, an adjacent signal wire adjacent to the looped signal wire, and a binder binding the looped signal wire and the adjacent signal wire.

In the module, the binder binds the twisted portion at a first turn from the looped end of the looped signal wire.

In the module, the looped signal wire connects the multiple terminals of data signal and a ground, or the multiple terminals of differential signals.

A writing unit includes the module. The unit includes a laser diode (LD) unit to emit a laser beam in accordance with a laser drive signal input via the multiple signal wires.

An image forming apparatus includes the writing unit.

Although the image forming apparatus according to the above-described embodiments is a multifunction peripheral having at least two functions of copying, printing, scanning, and facsimile transmission, aspects of the present disclosure are applicable to any image forming apparatus such as a copier, a printer, a scanner, or a facsimile machine. Aspects of the present disclosure are, for example, as follows.

### First Aspect

A module includes a unit including a connector. The connector includes multiple terminals to each of which a signal wire is connected. The signal wire that is connected to an open terminal among the multiple terminals is a looped signal wire in which an end of the signal wire is formed in a loop shape, and the looped signal wire has a twisted shape.

### Second Aspect

In the module according to the first aspect, the looped signal wire has a length that causes the operating frequency of the adjacent signal wire and the resonance frequency of the looped signal wire not to coincide with each other.

### Third Aspect

In the module according to the first or second aspect, the looped signal wire has a length that does not affect ease of assembling of the module.

### Fourth Aspect

In the module according to any one of the first to third aspect, the looped signal wire is fixed to the adjacent signal wire by binding.

### Fifth Aspect

In the module according to the fourth aspect, the looped signal wire is fixed by binding at a twisted portion of a first turn from a looped end of the looped signal wire.

### Sixth Aspect

In the module according to any one of the first to fifth aspect, the looped signal wire is a looped signal wire that connects the looped signal wire and a GND or connects differential signals to each other.

### Seventh Aspect

In the module according to any one of the first to sixth aspect, the unit is an LD unit that emits a laser beam in accordance with a laser drive signal input via the signal wire.

### Eighth Aspect

An image forming apparatus includes the module according to the seventh aspect.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A module comprising a unit including a connector including multiple terminals connectable to multiple signal wires,
wherein the multiple terminals include open terminals,
the multiple signal wires are connectable to the open terminals,
the multiple signal wires include a looped signal wire having a looped end, and
the looped signal wire includes a twisted portion between the looped end and the open terminals.

2. The module according to claim 1,
wherein the multiple signal wires includes:
the looped signal wire; and
an adjacent signal wire adjacent to the looped signal wire,
the adjacent signal wire transmits an electrical signal at an operating frequency via the adjacent signal wire, and
the looped signal wire has a length, from the multiple terminals to the looped end, that causes a resonant frequency of the looped signal wire to be shifted from the operating frequency of the adjacent signal wire.

3. The module according to claim 1,
wherein the adjacent signal wire connects the multiple terminals and an apparatus body,
the looped signal wire has a length having:
a lower limit allowing the loop signal wire to be twisted one or more times; and
an upper limit of a distance from the apparatus body to the multiple terminals.

4. The module according to claim 1,
wherein the multiple signal wires includes:
the looped signal wire;
an adjacent signal wire adjacent to the looped signal wire; and
a binder binding the looped signal wire and the adjacent signal wire.

5. The module according to claim 4,
wherein the binder binds the twisted portion at a first turn from the looped end of the looped signal wire.

6. The module according to claim 1,
wherein the looped signal wire connects:
the multiple terminals of data signal and a ground; or
the multiple terminals of differential signals.

7. A writing unit comprising the module according to claim 1,
wherein the unit includes a laser diode unit to emit a laser beam in accordance with a laser drive signal input via the multiple signal wires.

8. An image forming apparatus comprising the writing unit according to claim 7.
